(19) United States
(12) Patent Application Publication
(10) Pub. No.: US 2024/0412702 A1
(43) Pub. Date: Dec. 12, 2024

(54) IMAGE DISPLAY CONTROL DEVICE, IMAGE DISPLAY SYSTEM, AND IMAGE DISPLAY CONTROL METHOD

(71) Applicant: Socionext Inc., Kanagawa (JP)

(72) Inventors: Shinichi TOMIOKA, Yokohama (JP); Nobutaka YAMAGISHI, Yokohama (JP)

(21) Appl. No.: 18/808,734

(22) Filed: Aug. 19, 2024

Related U.S. Application Data
(63) Continuation of application No. PCT/JP2022/007111, filed on Feb. 22, 2022.

(51) Int. Cl. G09G 3/34; G09G 3/20

(52) U.S. Cl. CPC G09G 3/3426; G09G 3/2092; G09G 2320/0233; G09G 2320/0686; G09G 2340/12

(57) ABSTRACT

An image display control device with a local dimming function includes: a brightness control unit to control brightness of a plurality of light sources based on first image information representing images to be displayed on a display unit, the light sources being included in a backlight; a pixel compensation unit to generate second image information by correcting pixel values included in the first image information based on the brightness of each light source; a first statistics obtaining unit to obtain first statistical data with respect to the pixel values included in the first image information; a second statistics obtaining unit to obtain second statistical with data respect to pixel values included in the second image information; and an anomaly detection unit to detect an anomaly of the brightness control unit or the pixel compensation unit based on the difference of the second statistical data from the first statistical data.

### CROSS-REFERENCE TO RELATED APPLICATION

The present application is a continuation application filed under 35 U.S.C. 111 (a) claiming the benefit under 35 U.S.C. 120 and 365 (c) of PCT International Application No. PCT/JP2022/007111, filed on Feb. 22, 2022, and designating the U.S. The entire contents of PCT International Application No. PCT/JP2022/007111 are incorporated herein by reference.

### BACKGROUND OF THE INVENTION

### 1. Field of the Invention

The present invention relates to an image display control device, an image display system, and an image display control method.

### 2. Description of the Related Art

Among display devices that use multiple light sources for the backlight, display devices that can quickly report the locations of failed light sources among multiple light sources have been known heretofore. In addition, display control devices that can check whether the data displayed on the display device is normal or not by applying cyclic redundancy check to the image data have been known heretofore.

### CITATION LIST

### Patent Document

[Patent Document 1] Unexamined Japanese Patent Application Publication No. 2013-3472
[Patent Document 2] Unexamined Japanese Patent Application Publication No. 2012-35677

### SUMMARY OF THE INVENTION

One aspect of embodiments of the present invention provides an image display control device with a local dimming function, including:
a brightness control unit configured to control a brightness of each of a plurality of light sources based on first image information representing images to be displayed on a display unit, the plurality of light sources being included in a backlight;
a pixel compensation unit configured to generate second image information by correcting pixel values included in the first image information based on the brightness of each of the plurality of light sources;
a first statistics obtaining unit configured to obtain first statistical data with respect to the pixel values included in the first image information;
a second statistics obtaining unit configured to obtain second statistical data with respect to pixel values included in the second image information; and
an anomaly detection unit configured to detect an anomaly of the brightness control unit or the pixel compensation unit based on an amount of difference of the second statistical data from the first statistical data.

### BRIEF DESCRIPTION OF DRAWINGS

FIG. 1 is a block diagram that illustrates an example of an image display system according to a first embodiment;

FIG. 2 is a block diagram that illustrates an example of the display controller of FIG. 1;

FIG. 3 is a block diagram that illustrates an example of the local dimming unit of FIG. 2;

FIG. 4 is a diagram that illustrates an example of backlight brightness control by the brightness control unit of FIG. 3;

FIG. 5 is a diagram that illustrates an example in which the brightness distribution calculation unit of FIG. 3 calculates a distribution of brightness;

FIG. 6 is a diagram that illustrates an example in which the RGB correction unit of FIG. 3 corrects the brightness of an image;

FIG. 7 is a diagram that illustrates an example of statistical information obtained by the input statistics obtaining unit and the output statistics obtaining unit of FIG. 3;

FIG. 8 is a diagram that illustrates an example process in which the processor of FIG. 3 detects anomalies in the local dimming unit;

FIG. 9 is a flowchart that illustrates an example process in which the processor of FIG. 3 detects anomalies in the local dimming unit;

FIG. 10 is a flowchart that illustrates an example of the process in step S80 of FIG. 9;

FIG. 11 is a diagram that illustrates example operations of a processor included in a display control device, in an image display system according to a second embodiment;

FIG. 12 is a flowchart that illustrates an example process in which the processor of FIG. 11 detects anomalies in the local dimming unit;

FIG. 13 is a diagram that illustrates example operations of a processor mounted in a display controller, in an image display system according to a third embodiment;

FIG. 14 is a flowchart that illustrates an example process in which a processor that operates as shown in FIG. 13 detects anomalies in the local dimming unit;

FIG. 15 is a flowchart that illustrates an example of the process in step S14 of FIG. 14;

FIG. 16 is a block diagram that illustrates an example of a display control device mounted in an image display system according to a fourth embodiment;

FIG. 17 is a block diagram that illustrates an example of the local dimming unit of FIG. 16;

FIG. 18 is a diagram that illustrates an example of statistical data that the internal statistics obtaining unit of FIG. 17 obtains;

FIG. 19 is a flowchart that illustrates an example process in which the processor of FIG. 17 detects anomalies in the local dimming unit;

FIG. 20 is a diagram that illustrates an example of a frame image for use in detection of anomalies in the local dimming unit; and

FIG. 21 is a block diagram that illustrates an example of a display control device mounted in an image display system according to a fifth embodiment.

### DETAILED DESCRIPTION OF THE PREFERRED EMBODIMENTS

Regarding image display control devices that display images on a display device having backlight, recently, the demand for local dimming is increasing. When an anomaly occurs in an image display control device's processing unit where local dimming is performed, there is a risk that the brightness or color tone of images displayed on the display device might change. However, a change in the brightness or color tone of an image may not be detected by applying cyclic redundancy check to the image data. In addition, an image display control device for use in a vehicle may display attention-drawing icons on the display device to alert the driver or other occupants. Because icons of this type need to satisfy the requirements of ASIL (Automotive Safety Integrity Level), it is more desirable to detect changes with images due to anomalies in the local dimming unit.

According to embodiments of the present invention, it is possible to provide an image display control device that can detect anomalies in the processing unit where local dimming is performed.

Embodiments of the present invention will be described below with reference to the accompanying drawings. In the following description, image data may be referred to simply as “image.”

### First Embodiment

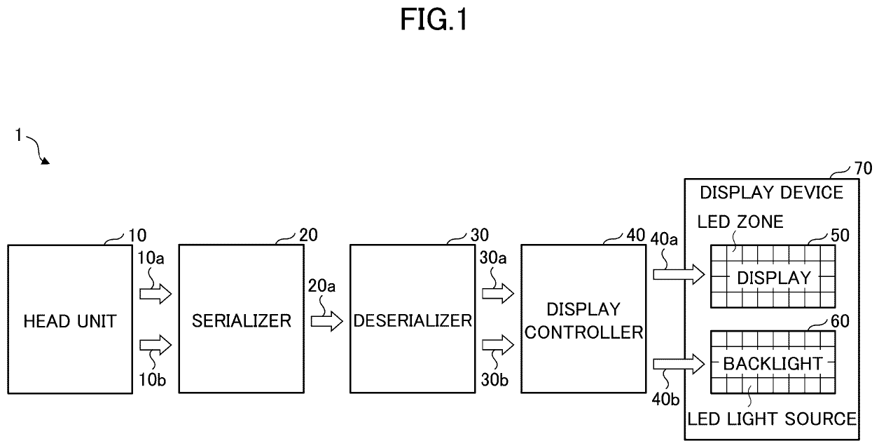

FIG. 1 is a block diagram that illustrates an example of an image display system according to a first embodiment. In FIG. 1, an image display system 1 includes a head unit 10, a serializer 20, a deserializer 30, a display controller 40, and a display device 70 that includes a display 50 and a backlight 60.

The head unit 10 generates an image to be displayed on the display 50. The head unit 10 outputs control information 10b, image data 10a and corresponding to the generated image, to the serializer 20. For example, the control information 10b includes information for use for controlling the display of the image on the display 50. The image data 10a may include, for example, a superimposition image, such as an icon, that is laid over the original image. In the examples and embodiments described below, the superimposition image to be laid over the original image is an icon.

The serializer 20 converts the image data 10a and the control information 10b, output from the head unit 10, into serial data 20a. The serializer 20 transmits the serial data 20a obtained by the conversion to the deserializer 30 via one video link (transmission channel). The serial data 20a is transmitted and received via the video link, using an interface such as LVDS (Low Voltage Differential Signaling) or APIX (Automotive Pixel Link) interface, but this is by no means a limitation.

The deserializer 30 converts the serial data 20a, received via the video link, into image data 30a and control information 30b. The image data 30a and the control information 30b correspond, respectively to the original image data 10a and the control information 10b output from the head unit 10. The deserializer 30 outputs the image data 30a and control information 30b, obtained by the conversion, to the display controller 40.

Based on the image data 30a and control information 30b received from the deserializer 30, the display controller 40 outputs information 40a, including image data representing an image to be displayed on the display 50, to the display 50. Based on the image data 30a and control information 30b, the display controller 40 outputs information 40b for controlling the brightness of the backlight 60 to the backlight 60. The display controller 40 is an example of an image display control device.

The image data input to the display controller 40 and the image data output from the display controller 40 include pixel values of red (R) pixels, green (G) pixels, and blue (B) pixels, which represent RGB color space, but this is by no means a limitation.

The display 50 is a liquid crystal display including, for example, a liquid crystal shutter for correcting the transmittance of light emitted from the backlight 60, and a color filter for receiving the light having transmitted through the liquid crystal shutter. The display 50 does not necessarily have to be a liquid crystal display as long as the transmittance of light emitted from the backlight 60 can be corrected. The display 50 is an example of a display.

The backlight 60 includes multiple LED (Light Emitting Diode) light sources that are arranged in a matrix, and is positioned to face the opposite side of the image-displaying face of the image in the display 50. As used herein, a “light emitting zone” refers to an LED light source in the display 50, and is therefore referred to as an “LED zone.” Note that the backlight 60 may include multiple light sources other than the LED light sources arranged in a matrix.

For example, the image display system 1 may be mounted in a vehicle. In this case, the display device 70 may be used, for example, to display the instrument cluster on the instrument panel or the center information display (CID). Alternatively, the display device 70 may be used for a head-up display that projects images onto the windshield.

The image display system 1 to be mounted on the vehicle is designed to meet the requirements of ASIL (Automotive Safety Integrity Level). Note that the image display system 1 incorporating a backlight and having a local dimming function is by no means limited to use in vehicles, and may be designed as a different image display system such as one for digital signage.

For example, the display controller 40 performs local dimming for correcting the brightness of multiple LED backlight sources individually in accordance with the brightness (for example, the pixel values) of the image to be displayed on the display 50. Note that, in local dimming, the display controller 40 exerts control such that the light that leaks to or near the location across from the LED backlight is prevented or substantially prevented from increasing the brightness of nearby images. By employing local dimming, black can be reproduced in improved conditions in images displayed on the display 50, while the power consumption of the backlight 60 is reduced.

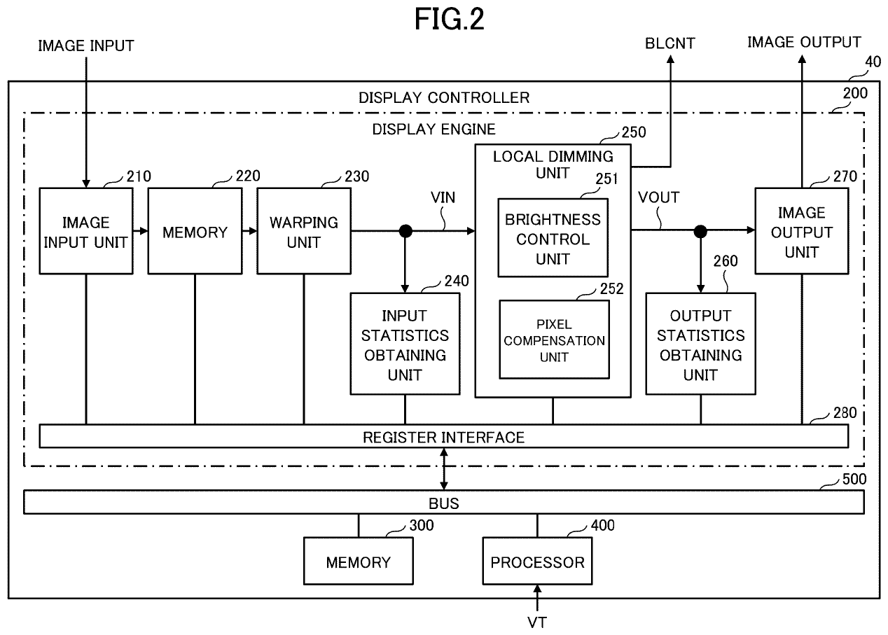

FIG. 2 is a block diagram that illustrates an example of the display controller 40 of FIG. 1. The display controller 40 is, for example, a semiconductor integrated circuit, and has a display engine 200, a memory 300, and a processor 400 that are connected with each other via a bus 500.

The display engine 200 includes an image input unit 210, a memory 220, a warping unit 230, an input statistics obtaining unit 240, a local dimming unit 250, an output statistics obtaining unit 260, an image output unit 270, and a register interface 280. The local dimming unit 250 includes a brightness control unit 251 and a pixel compensation unit 252. For example, each element of the display engine 200 operates under control of the processor 400. The display engine 200 processes image data that represents RGB color space, but this is by no means a limitation.

The image input unit 210 receives the image data (which may be, for example, input images per frame) transmitted from the deserializer 30 of FIG. 1, and stores the received image data in the memory 220. The memory 220 is an example of a holding unit for holding image data VIN that is input to the local dimming unit 250. Using the image data stored in the memory 220, the warping unit 230 performs distortion correction to display an image without distortion on the display 50 of FIG. 1. The warping unit 230 outputs the image data having undergone distortion correction to the local dimming unit 250.

When the image data VIN is input from the warping unit 230 to the local dimming unit 250, the unit 240 obtains input statistics obtaining statistical data based on the pixel values of the region of the display where the icon is superimposed on the original image is included. The statistical data that the input statistics obtaining unit 240 obtains is an example of first statistical data. The image data VIN is first an example of image information. The input statistics obtaining unit 240 is an example of a first statistics obtaining unit. For example, the input statistics obtaining unit 240 receives information representing the part of the display including the icon from the deserializer 30 of FIG. 1 or the processor 400 of FIG. 2. When the image display system 1 is used in a vehicle, the icon then may be, for example, a warning icon for alerting the driver that the surface of the road is slippery, but this is by no means a limitation.

The input statistics obtaining unit 240 outputs the obtained statistical data the to processor 400, via the register interface 280 and the bus 500. The input statistics obtaining unit 240 may have a memory unit, such as a buffer, for holding the statistical data of pixel values. In this case, the statistical data held in the memory unit may be read by the processor 400. Note that the input statistics obtaining unit 240 does not obtain statistical data when no icon is found in the image data VIN.

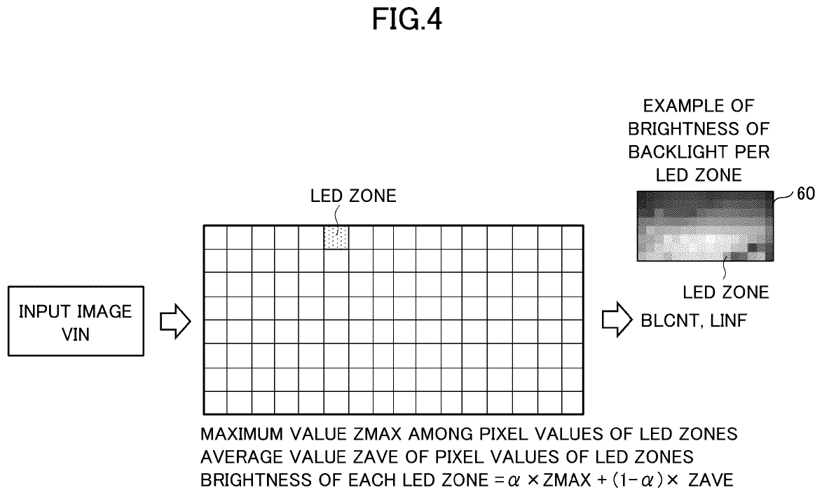

The brightness control unit 251 of the local dimming unit 250 generates a backlight control signal BLCNT, which is for correcting the brightness of the backlight 60 of FIG. 1 based on the image data VIN, and outputs the generated backlight control signal BLCNT to the backlight 60. That is, the display controller 40 has a local dimming function. The method that the brightness control unit 251 uses to correct the brightness of the backlight 60 will be described later with reference to FIG. 4.

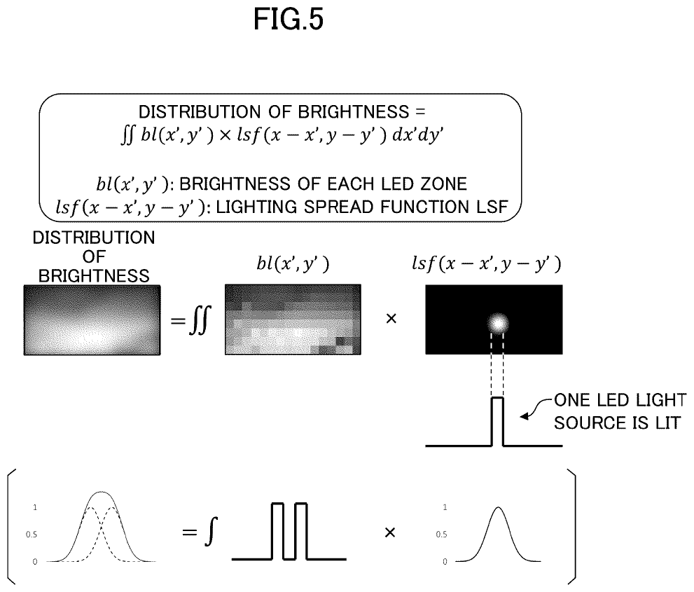

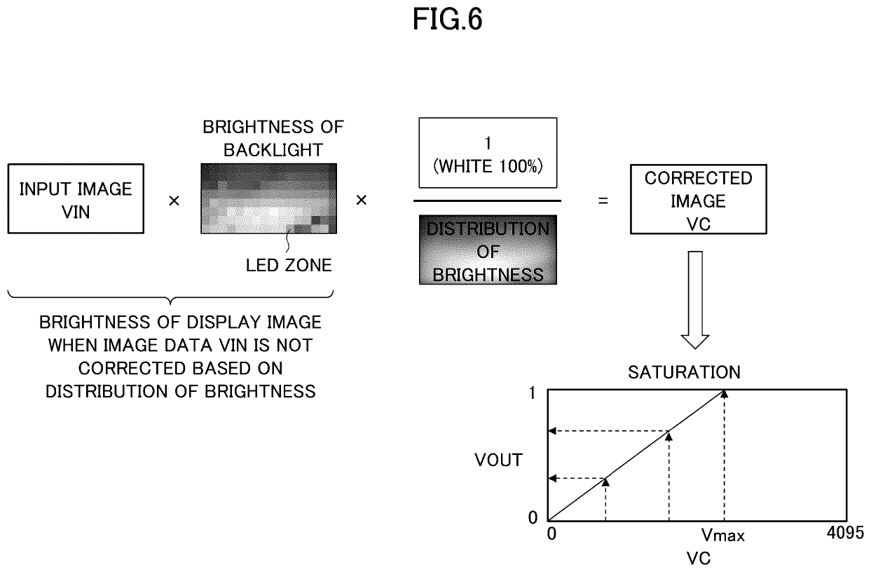

The pixel compensation unit 252 of the local dimming unit 250 corrects the pixel values (for example, the brightness values) of the image data VIN based on the brightness of the backlight 60, which is corrected by the brightness control unit 251, and outputs the corrected pixel values to the image output unit 270 as image data VOUT. The image data VOUT is an example of second image information. For example, the pixel compensation unit 252 corrects pixel values such that the pixel values in a part where the brightness of the backlight 60 is high are made relatively small and the pixel values in a region where the brightness of the backlight 60 is low are made relatively large. In doing so, the pixel compensation unit 252 corrects the pixel values by taking into account the leakage of light around each LED light source. The method that the local dimming unit 250 uses to correct images will be later described with reference to FIG. 5 and FIG. 6.

When the image data VOUT is output from the local dimming unit 250 to the image output unit 270, the output statistics obtaining unit 260 obtains statistical data based on the pixel values in the part of the display where an icon is superimposed on the original image. The statistical data that the output statistics obtaining unit 260 obtains is an example of second statistical data. The output statistics obtaining unit is an 260 example of a second statistics obtaining unit. For example, the output statistics obtaining unit 260 receives information representing the part of the display where the icon is placed, from the deserializer 30 of FIG. 1 or the processor 400 of FIG. 2.

The output statistics obtaining unit 260 outputs the obtained statistical data to the processor 400 via the register interface 280 and the bus 500. Note that the output statistics obtaining unit 260 may have a memory unit such as a buffer for holding statistical data of pixel values. In this case, the statistical data held in the memory unit may be read by the processor 400. The output statistics obtaining unit 260 does not obtain statistical data when no icon is found in the image data VC.

The image output unit 270 transmits the image data VOUT (which is, for example, output images per frame) received from the local dimming unit 250, to the display 50 of FIG. 1, and displays an image on the display 50.

The memory 300 holds, for example, an image display control program that is executed by the processor 400, data for use in the image display control program, and so on. The processor 400 is a controller such as a CPU (Central Processing Unit) or a GPU (Graphics Processing Unit). For example, the processor 400 controls the operation of the display controller 40 by executing an image display control program.

For example, by executing an image display control program, the processor 400 detects anomalies in the local dimming unit 250 (the brightness control unit 251 or the pixel compensation unit 252) based on the statistical data obtained by the input statistics obtaining unit 240 and the output statistics obtaining unit 260. The functional unit in the processor 400 for detecting anomalies in the local dimming unit 250 is an example of an anomaly detection unit. The processor 400 can make the detection of anomalies easy or difficult depending on a threshold VT, which is received from outside. The threshold VT may be supplied from outside the image display system 1.

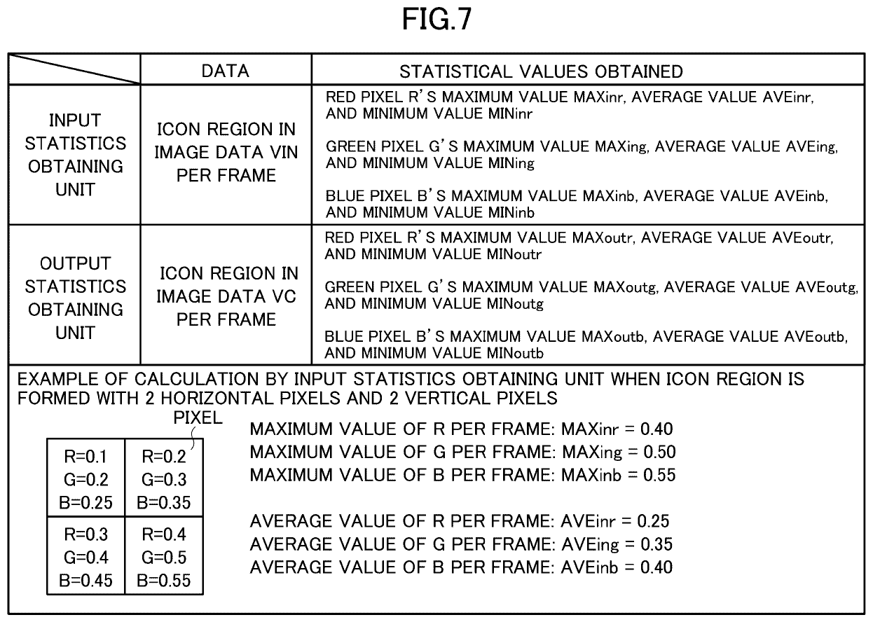

Note that the processor 400 does not detect anomalies in the local dimming unit 250 when no statistical data is obtained in the input statistics obtaining unit 240 or the output statistics obtaining unit 260. The detection of anomalies in the local dimming unit 250 will be described later with reference to FIG. 7 to FIG. 10.

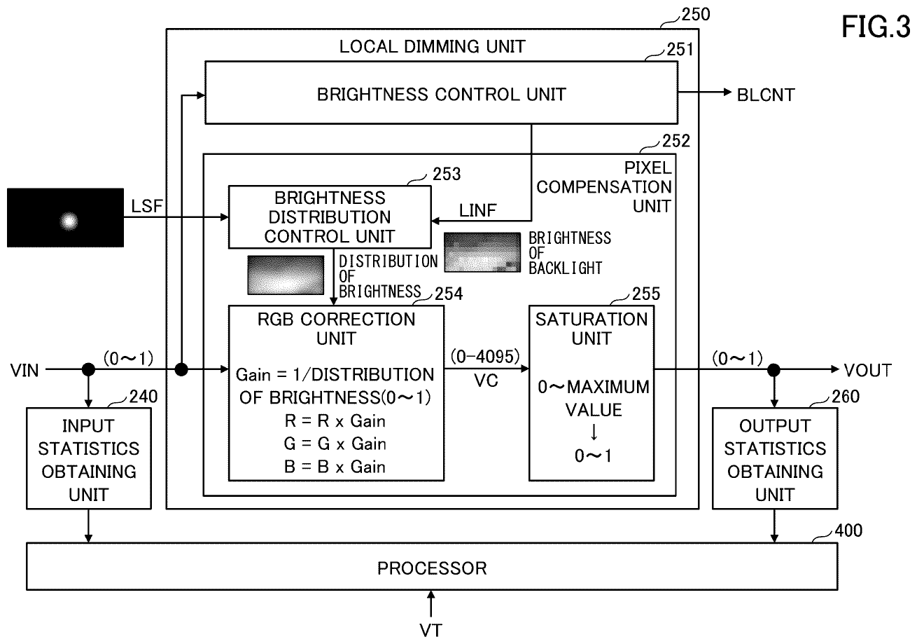

FIG. 3 is a block diagram that illustrates an example of the local dimming unit 250 of FIG. 2. In FIG. 3, the register interface 280 and the bus 500 of FIG. 2 are not illustrated. The pixel compensation unit 252 of the local dimming unit 250 includes a brightness distribution calculation unit 253, an RGB correction unit 254, and a saturation unit 255.

The brightness distribution calculation unit 253 receives brightness information LINF, which indicates the brightness of each LED light source, and an LSF (Lighting Spread Function), which is a brightness distribution function for use when only one LED light source is lit. The brightness information LINF is supplied from the brightness control unit 251. The brightness information LINF may carry information that is the same or substantially the same as that included in the backlight control signal BLCNT, or may be a backlight control signal BLCNT itself. The brightness distribution function LSF is supplied from the memory 300, for example. Based on the brightness information LINF and the brightness distribution function LSF, the brightness distribution calculation unit 253 generates a distribution of brightness for the backlight 60, taking into account the leakage of light to the surroundings of the LED light sources, and outputs the generated distribution of brightness to the RGB correction unit 254. For example, the distribution of brightness generated thus by the brightness distribution calculation unit 253 shows the distribution of the brightness of the backlight 60 in every and all individual pixels of the display 50, and is represented by a value between 0 and 1, inclusive. The value is closer to 0 when the brightness in the distribution of brightness is lower, or closer to 1 when the brightness in the distribution of brightness is higher.

The RGB correction unit calculates the gains for pixel values, that is, the gain to apply to every pixel of the display 50, based on the distribution of brightness (brightness value) based on an equation 1. According to equation 1, the minimum value of gain becomes 1 and the maximum value of gain becomes infinite. Infinity in this case is the maximum value that the bits representing gain can represent:

Gain=1/distribution of brightness (Equation 1)

Furthermore, based on equations 2-1, 2-2, and 2-3 below, the RGB correction unit 254 calculates the pixel value of each color component by multiplying the pixel value of each color component in each pixel in the image data VIN by the gain calculated by equation 1. “R” in equation 2-1 indicates the pixel value of the red pixel. “G” in equation 2-2 indicates the pixel value of the green pixel. “B” in equation 2-3 indicates the pixel value of the blue pixel.

R=R×Gain (Equation 2-1)

G=G×Gain (Equation 2-2)

B=B×Gain. (Equation 2-3)

In FIG. 3, the pixel values of color components constituting each pixel of the image data VIN are represented by normalized values between 0 and 1, inclusive Consequently, when the image input unit 210 of FIG. 2 receives, as an input, 8 bits (the first number of bits) of image data (0 to 255) per pixel, the maximum value 255 becomes 1 in the representation of the image data VIN in FIG. 3. The RGB correction unit 254 outputs the calculated pixel values to the saturation unit 255 as image data VC. The image data VC is an example of internal image information.

For example, each pixel value of the image data VC is represented by 12 bits (which is a second number of bits and an expansion of the first number of bits). The minimum value is 0, and the maximum value is 4095. Note that the pixel values of the image data VC may be represented by a number of bits other than 12 bits (for example, 10 bits, 14 bits, etc.). If each pixel value of image data VIN is represented by 8 bits (0 to 255), the pixel values of the image data VC may be represented by 20 bits (0 to 1,044,225 (=255×4,095)).

The saturation unit 255 sets the maximum pixel value of the image data VC to 1, and normalizes the other pixel values between 0 and 1, inclusive, thus generating the image data VOUT. The saturation unit 255 outputs the generated image data VOUT to the display 50. As with the image data VIN, when 8 bits (the first number of bits) of image data (0 to 255) are output per pixel, the maximum value 255 becomes 1 in the representation of image data VOUT in FIG. 3.

The input statistics obtaining unit 240 obtains statistical data based on the image data VIN normalized between 0 and 1, inclusive. The output statistics obtaining unit 260 obtains statistical data based on the image data VOUT normalized between 0 and 1, inclusive. Thus, the pixel values of the image data VIN not having undergone correction of pixel values and the pixel values of the image data VOUT can be associated with each other. Note that the local dimming unit 250 of FIG. 3 may skip the saturation of pixel values by the saturation unit 255, and output the image data VC as the image data VOUT.

FIG. 4 shows an example in which the brightness control unit 251 of FIG. 3 controls the brightness of the backlight 60. For example, given image data VIN that corresponds to an input image, the brightness control unit 251 determines the maximum pixel value ZMAX and the average pixel value ZAVE per portion of the image data VIN corresponding to an LED zone of the backlight 60. Here, the maximum value ZMAX and the average value ZAVE are determined from the pixel values of red pixels, green pixels, and blue pixels constituting each LED zone.

Then, the brightness control unit 251 calculates the brightness of each LED zone based on equation 3, outputs a backlight control signal BLCNT representing the brightness determined by the calculation to the backlight 60, and outputs brightness information LINF to the pixel compensation unit 252. In equation 3, the symbol α is a parameter for correction of brightness and is set between 0 and 1, inclusive. For example, when the parameter α is 0.5, 50% of the maximum value ZMAX and 50% of the average value ZAVE are mixed.

Brightness of each LED zone=α×ZMAX+(1−α)×ZAVE (Equation 3)

FIG. 5 is a diagram that illustrates an example in which the brightness distribution calculation unit of 253 FIG. 3 generates a distribution of brightness. The brightness distribution calculation unit 253 determines the distribution of brightness by executing convolution integration on the brightness information LINF and the brightness distribution function LSF, per LED zone of the backlight 60.

In the equation shown in FIG. 5, the symbol x and the symbol y are the horizontal coordinate and the vertical coordinate of the target LED zone, respectively. bl (x′, y′) is the brightness of each LED zone, and lsf (x-x′, y-y′) is the brightness distribution function LSF. Inside the large brackets at the bottom of FIG. 5 is an image showing how the distribution of brightness is determined based on convolution integration when two LED light sources are lit and the rest of the LED light sources are not lit.

FIG. 6 shows an example in which the RGB correction unit 254 of FIG. 3 corrects the brightness of an image. When an input image's image data VIN is output as image data VOUT without correction based on the distribution of brightness, the brightness of the image displayed on the display 50 is the product of the brightness of the input image and the brightness of the backlight, and therefore the image is not displayed with a proper brightness.

Therefore, as shown in FIG. 6, the RGB correction unit 254 calculates gains for every pixel (per R, G, and B) of the image data VIN using equation 1, and multiplies the pixel values of the image data VIN by the calculated gains, so that the brightness of the backlight 60 is cancelled. Thus, by using the light from the backlight 60 where the brightness of LED light sources is corrected individually according to the brightness of an image, the brightness of the image displayed on the display 50 can be set properly.

In the saturation of pixel values in the saturation unit 255 of FIG. 3, the maximum value Vmax among all the pixel values included in the image data VC, which is an corrected image, is set to the pixel value 1 of the image data VOUT.

FIG. 7 is a diagram that illustrates an example of statistical data that the input statistics obtaining unit 240 and the output statistics obtaining unit 260 of FIG. 3 obtain. The input statistics obtaining unit 240 determines the maximum value MAXin, the average value AVEin, and the minimum value MINin from among the pixel values of the pixels in the icon region, which is the region of the display where the icon included in each frame's image data VIN is placed. The icon region is an example of a superimposition region.

Likewise, the output statistics obtaining unit 260 determines, per pixel color, the maximum value MAXout, the average value AVEout, and the minimum value MINout among the pixel values of the pixels in the icon region, which is the region of the display where the icon included in each frame's image data VC is placed.

At the maximum values MAXin and MAXout, the average values AVEin and AVEout, and the minimum values MINin and MINout, the color of each pixel component is identified by the letter “r” (red), “g” (green), or “b” (blue), appended at the end of each value. FIG. 7 illustrates an example of calculation by the input statistics obtaining unit 240 in the event the icon is formed with 2 horizontal pixels and 2 vertical pixels.

Note that the input statistics obtaining unit 240 may obtain only one of the maximum value MAXin, the average value AVEin, or the minimum value MINin. In this case, the output statistics obtaining unit 260 may likewise obtain only one of the maximum value MAXout, the average value AVEout, and the minimum value MINout that matches the statistical data obtained by the input statistics obtaining unit 240.

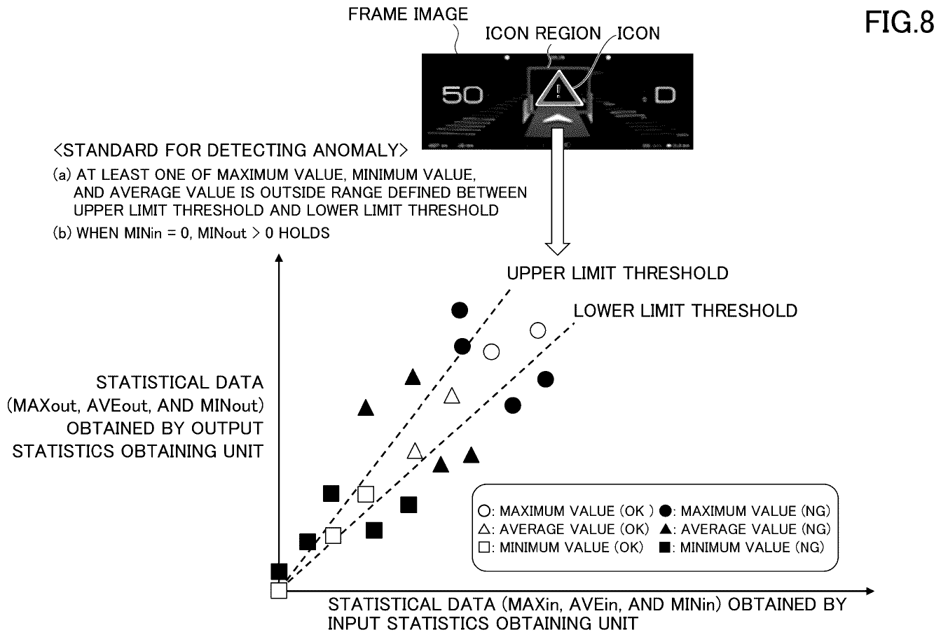

FIG. 8 shows an example in which the processor 400 of FIG. 3 detects anomalies in the local dimming unit 250. The processor 400 determines, per pixel color, whether the amount of difference between the maximum value among the pixel values in the icon part obtained by the input statistics obtaining unit 240 and the maximum value among the pixel values in the icon part obtained by the output statistics obtaining unit 260 falls between an upper-limit threshold and a lower-limit threshold.

The processor 400 determines, per pixel color, whether the amount of difference between the average value of the pixel values in the icon part obtained by the input statistics obtaining unit 240 and the average value of the pixel values in the icon part obtained by the output statistics obtaining unit 260 falls between the upper-limit threshold and the lower-limit threshold.

The processor 400 determines, per pixel color, whether the amount of difference between the minimum value among the pixel values in the icon region obtained by the input statistics obtaining unit 240 and the minimum value among the pixel values in the icon region obtained by the output statistics obtaining unit 260 falls between the upper-limit threshold and the lower-limit threshold. In the event the minimum value among the pixel values in the icon region obtained by the input statistics obtaining unit 240 is 0, the processor 400 determines, per pixel color, whether the minimum value among the pixel values in the icon region obtained by the output statistics obtaining unit 260 is greater than 0.

Then, the processor 400 detects an anomaly of the local dimming unit 250 when at least one amount of difference is greater than the upper-limit threshold or when at least one amount of difference falls below the lower-limit threshold. That is, the processor 400 detects an anomaly of the local dimming unit 250 when the proportion of change in the statistical data obtained by the output statistics obtaining unit 260, relative to the statistical data obtained by the input statistics obtaining unit 240, is greater than a predetermined range.

The processor 400 also detects an anomaly of the local dimming unit 250 when the minimum value among the pixel values in the icon region obtained by the input statistics obtaining unit 240 is 0 and the minimum value among the pixel values in the icon region obtained by the output statistics obtaining unit 260 is greater than 0. For the purpose of illustrating how the amount of difference varies, FIG. 8 shows six symbols that represent the amount of difference of each maximum value, average value, and minimum value, and two symbols that represent the amount of difference of each minimum value when the input statistics obtaining unit 240 obtains the minimum value=0.

The processor 400 detects anomalies in the local dimming unit 250 based on the statistical data obtained by the input statistics obtaining unit 240 and the output statistics obtaining unit 260. For example, when the input statistics obtaining unit 240 obtains only the maximum value MAXin and the output statistics obtaining unit 260 obtains only the maximum value MAXout, the processor 400 detects an anomaly of the local dimming unit 250 based on these maximum values alone.

Here, since the pixel value of the image outside the icon region might vary depending on the content, there might be instances in which it is difficult to set the range for detecting anomalies based on an upper-limit threshold and a lower-limit threshold (that is, instances in which the accuracy of anomaly detection decreases). By contrast with this, the icon superimposed on the image is a figure known to the display controller 40, and the icon's pixel values are also known to the display controller 40. Therefore, obtaining statistical data based on the pixel values of the icon region can reduce the content dependence of pixel values, and the range for detecting anomalies can be set as appropriate based on an upper-limit threshold and a lower-limit threshold. As a result of this, the accuracy of anomaly detection can be improved.

For example, since the gains for the icon region are maximized when the pixel values of pixels outside the icon region are minimum (black), the upper-limit threshold is set in advance in accordance with the maximum gain value in the icon region. Also, since the gains for the icon region are minimized when the pixel values of pixels outside the icon region are maximum (white), the lower-limit threshold is set in advance in accordance with the minimum gain value in the icon region. In the event saturation, by which the maximum value of pixel values multiplied by gains is corrected to 1, is performed, the upper-limit threshold is: the maximum value 1+calculation error.

For example, assuming a case in which the image display system 1 is used for the instruments or the center information display of the instrument panel of a vehicle, the original image before an icon is superimposed thereon is usually a predetermined image. In this case, the upper and lower-limit thresholds may be set in accordance with the values of gains measured using the actual image.

The input statistics obtaining unit 240 and the output statistics obtaining unit 260 may obtain statistical data based on the pixel values of the image corresponding to the LED zone where the icon region is placed. The processor 400 may also detect anomalies in the local dimming unit 250 per LED zone including the icon region. In this case, the processor 400 may perform anomaly detection by using each LED zone as an icon region.

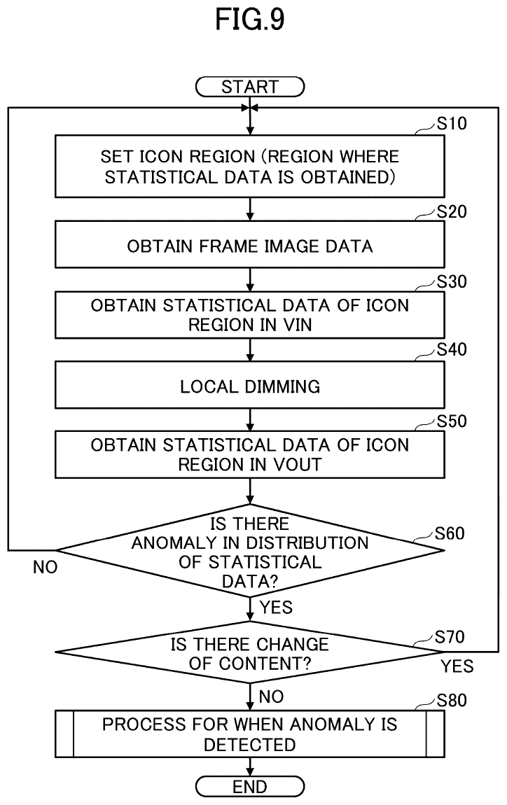

FIG. 9 is a flowchart that illustrates an example process in which the processor 400 of FIG. 3 detects anomalies in the local dimming unit 250. That is, FIG. 9 illustrates an example of the image display control method that the processor 400 performs and an image display control program that the processor 400 executes. The flow shown in FIG. 9 is started upon activation of the image display system 1 or activation of the display controller 40. Step S10 to step S70 are performed per frame.

First, in step S10, the processor 400 sets an icon region (that is, a region from which statistical data is obtained), which is a region of the display where an icon is superimposed on the original image. The processor 400 may obtain information that indicates the icon region, from the head unit 10 via the serializer 20 and deserializer 30 shown in FIG. 1.

Next, in step S20, the processor 400 causes the image input unit 210 to obtain frame image data. In step S30, the processor 400 causes the input statistics obtaining unit 240 to obtain statistical data from the icon region included in image data VIN. In step S40, the processor 400 causes the local dimming unit 250 to perform local dimming.

Next, in step S50, the processor 400 causes the output statistics obtaining unit 260 to obtain statistical data from the icon region included in image data VOUT. In step S60, the processor 400 determines whether or not there is an anomaly of the local dimming unit 250 based on the statistical data obtained by the input statistics obtaining unit 240 and the statistical data obtained by the output statistics obtaining unit 260. The detection of anomalies in the local dimming unit 250 is as described earlier with reference to FIG. 8. When the processor 400 detects an anomaly of the local dimming unit 250, the process proceeds to step S70. When the processor 400 detects no anomaly of the local dimming unit 250, the process returns to step S10.

In step S70, the processor 400 determines whether or not there is a change in the content of the image to be displayed on the display 50. When there is a change of content, the processor 400 determines that an anomaly is detected because the amount of difference of the statistical data has increased due to the change of content, and the process returns to step S10. If there is no change of content, the processor 400 moves the process to step S80.

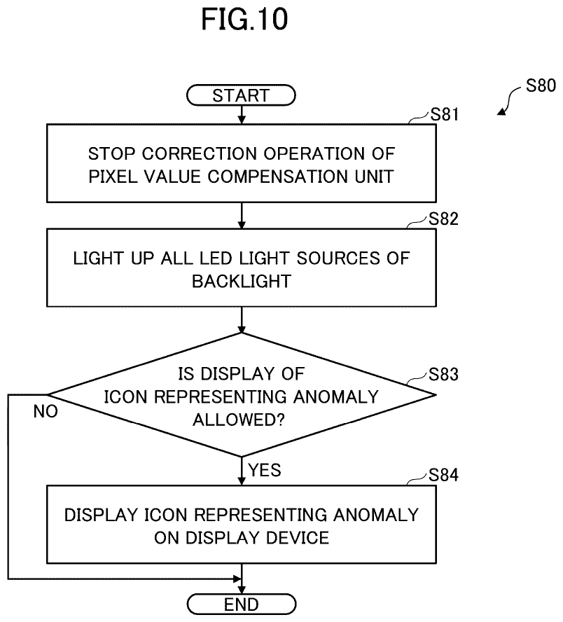

In step S80, the processor 400 performs a process for when an anomaly is detected in the local dimming unit 250, and terminates the process of FIG. 9. An example of step S80 is shown in FIG. 10.

When the processor 400 determines in step S70 that the content has changed, the processor 400 may stop the anomaly detection of step S60 for at least a period of 1 frame, and return the process back to step S10 based on the assumption that the local dimming unit 250 is in normal condition. Also, when the image display system 1 or the display controller 40 is activated, the processor 400 may stop the anomaly detection of step S60 for at least a period of 1 frame, f and return the process back to step S10 based on the assumption that the local dimming unit 250 is in normal condition. As a result of this, it is possible to prevent or substantially prevent anomalies from being misdetected in the local dimming unit 250 when, for example, the image becomes unstable upon change of its content.

FIG. 10 is a flowchart that illustrates an example of the process in step S80 of FIG. 9. First, in step S81, the processor 400 stops the pixel value correction operation of the pixel compensation unit 252. Then, the processor 400 outputs the image data VIN as image data VOUT, to the display 50, by ignoring the operation of the pixel compensation unit 252.

Next, in step S82, the processor 400 lights up all the LED light sources of the backlight 60 and sets the backlight 60 to a predetermined brightness level. That is, the processor 400 lights up all the LED light sources at a predetermined brightness level by ignoring the operation of the brightness control unit 251.

Thus, when an anomaly is detected in the local dimming unit 250, it is still possible to prevent or substantially prevent the display 50 from displaying an image with improper pixel values due to a malfunction of the pixel compensation unit 252. In addition, when an anomaly is detected in the local dimming unit 250, it is still possible to prevent or substantially prevent the LED light sources from being lit with an improper brightness due to the wrong backlight control signal BLCNT from the brightness control unit 251. Note that, when an anomaly is detected in the local dimming unit 250, the processor 400 may stop the operation of the input statistics obtaining unit 240 and the output statistics obtaining unit 260.

Next, in step S83, the processor 400 determines whether or not displaying an icon that represents an anomaly of the local dimming unit 250 is allowed. If an icon that represents an anomaly is allowed to be displayed, the processor 400 moves the process to step S84. If an icon representing an anomaly is not allowed to be displayed, the processor 400 terminates the process of FIG. 10.

In step S84, the processor 400 displays an icon that represents an anomaly, on the display 50, and terminates the process of FIG. 10. In step S84, the processor 400 may control the display 50 directly and display the icon representing an anomaly as an OSD (On Screen Display) on the display 50. In addition, the processor 400 may display the icon representing an anomaly on the display 50 by inputting image data representing the icon to the image input unit 210, or by overwriting the icon data in the image data holding unit of the memory 220.

According to this embodiment, an anomaly of the local dimming unit 250 that could not heretofore be detected based on the amount of difference between statistical data of image data VIN input to the pixel compensation unit 252 and statistical data of image data VOUT output from the pixel compensation unit 252. By obtaining statistical data from the pixel values of a superimposition image such as an icon having pixel values known in advance, the content dependence of pixel values can be reduced, and appropriate standards can be set for the detection of anomalies. For example, the range for detecting anomalies can be set as appropriate based on an upper-limit threshold and a lower-limit threshold. As a result of this, the accuracy of detection of anomalies in the local dimming unit 250 can be improved.

By obtaining a variety of statistical data such as maximum values, average values, and minimum values of pixel values, more strict standards can be applied to the detection of anomalies in the local dimming unit 250, so that the reliability of the display controller 40 can be improved.

The local dimming unit 250 does not detect anomalies for at least a period of 1 frame when the displayed image's content changes, the display controller 40 is activated, and so forth. As a result of this, it is possible to prevent or substantially prevent anomalies from being misdetected in the local dimming unit 250 when, for example, the image becomes unstable upon change of its content, upon activation of the image display system 1 or the display controller 40, and so forth.

By stopping the pixel value correction operation of the pixel compensation unit 252 when an anomaly is detected in the local dimming unit 250, it is possible to prevent or substantially prevent the display 50 from displaying an image with improper pixel values due to a malfunction of the pixel compensation unit 252. In addition, by lighting up all the LED light sources of the backlight 60 when an anomaly is detected in the local dimming unit 250, it is possible to prevent or substantially prevent the LED light sources from being lit by the wrong backlight control signal BLCNT from the brightness control unit 251.

### Second Embodiment

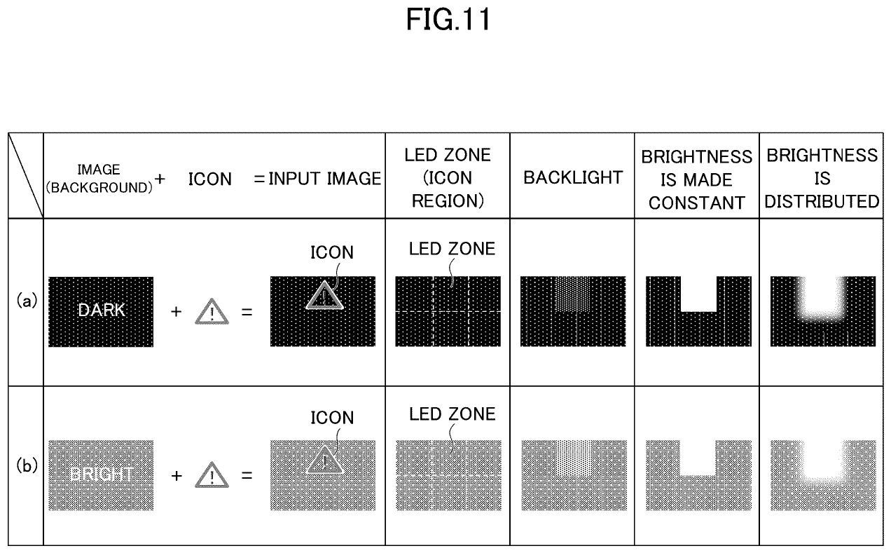

FIG. 11 is a diagram that illustrates example operations of the processor 400 included in the display controller 40, in an image display system according to a second embodiment. The image display system includes the controller 40 display incorporating the processor 400 that operates as shown in FIG. 11, and has the same structure and functions as those of the image display system 1 shown in FIG. 1. Elements that are the same or substantially the same as those described earlier with reference to FIG. 1 to FIG. 10 will be assigned the same reference and codes, their detailed description will be omitted.

The input statistics obtaining unit 240 and the output statistics obtaining unit 260 obtain the same statistical data as in FIG. 7. The method that the processor 400 uses to detect anomalies in the local dimming unit 250 is the same as that shown in FIG. 8. The process that is performed when an anomaly is detected in the local dimming unit 250 is the same as that shown in FIG. 10.

FIG. 11 shows, for ease of explanation, examples in which the icon region overlaps an LED zone and the backlight 60 has 6 LED light sources. (a) of FIG. 11 shows a case in which a dark image (background) is displayed on the display 50 of FIG. 1. (b) of FIG. 11 shows a case in which a bright image (background) is displayed on the display 50. The brightness control unit 251, illustrated in FIG. 3, lowers the brightness of the backlight 60 for darker images, and raises the brightness of the backlight 60 for brighter images. Therefore, the brightness of the LED zone corresponding to the icon region when the background is dark is lower than the brightness of the LED zone corresponding to the icon region when the background is bright.

Therefore, the gains calculated by the RGB correction unit 254 of FIG. 3 change depending on whether the background is bright or dark, which then changes the brightness of the icon. In this case, it is necessary to narrow the region between the upper-limit threshold and the lower-limit thresholds shown in FIG. 8, which widens the range for detecting anomalies in the local dimming unit 250. However, narrowing the region between the upper-limit threshold and the lower-limit thresholds raises a possibility that an anomaly might be detected even when there is no anomaly of the local dimming unit 250.

So, the processor 400 fixes the brightness of the LED zone where the icon is placed. Thus, the distribution of brightness in the icon region including the icon can be kept the same by ignoring the brightness of the background. As a result of this, it is not necessary to narrow the region between the upper-limit threshold and the lower-limit threshold, so that anomalies can be detected accurately in the local dimming unit 250.

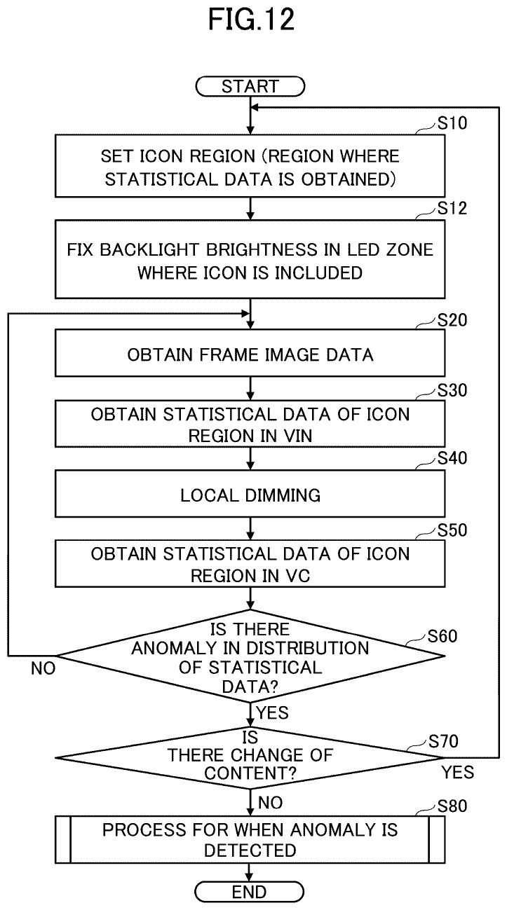

FIG. 12 is a flowchart that illustrates an example process in which the processor 400 that operates as shown in FIG. 11 detects anomalies in the local dimming unit 250. The structure and functions of the display controller 40 that performs the process of FIG. 12 are the same as those of the display controller 40 shown in FIG. 2 and FIG. 3, except that the processor 400 performs a different step.

During the process of detecting anomalies in the local dimming unit 250, the processor 400 of this embodiment performs step S12 between step S10 and step S20 of FIG. 9. Step S10 and steps S20 to S80 are the same as in FIG. 9. In step S12, the processor 400 causes the brightness control unit 251 of FIG. 3 to make constant the brightness of the LED zone corresponding to the icon region where the icon is to be placed, and then performs step S20. Thus, as described earlier with reference to FIG. 11, the distribution of brightness in the icon region where the icon is placed can be kept the same by ignoring the brightness of the background.

Note that, when the content changes, when the image display system 1 or the display controller 40 is activated, and so on, the processor 400 does not have to perform anomaly detection in step S60 for at least a period of 1 frame. In this case, the process returns to step S10 based on the assumption that the local dimming unit 250 is in normal condition.

As described above, this embodiment can bring about the same advantages as the above-described embodiment. For example, anomalies in the local dimming unit 250 can be detected based on the amount of difference between statistical data related to image data VIN and statistical data related to image data VOUT. When this is done, the content dependence of pixel values can be reduced by obtaining statistical data from the pixel values of a superimposition image such as an icon, so that appropriate standards can be set for anomaly detection. As a result of this, the accuracy of detection of anomalies in the local dimming unit 250 can be improved. Furthermore, when an anomaly is detected in the local dimming unit 250, it is still possible to prevent or substantially prevent an image with improper pixel values from being displayed on the display 50, and prevent or substantially prevent the LED light sources from being lit by the wrong backlight control signal BLCNT.

Furthermore, according to this embodiment, the brightness of the LED zone where the icon is placed is fixed, so that the distribution of brightness in the icon region including the icon can be kept the same by ignoring the brightness of the background. As a result of this, it is not necessary to narrow the region between the upper-limit threshold and the lower-limit threshold, so that anomalies in the local dimming unit 250 can be detected accurately.

### Third Embodiment

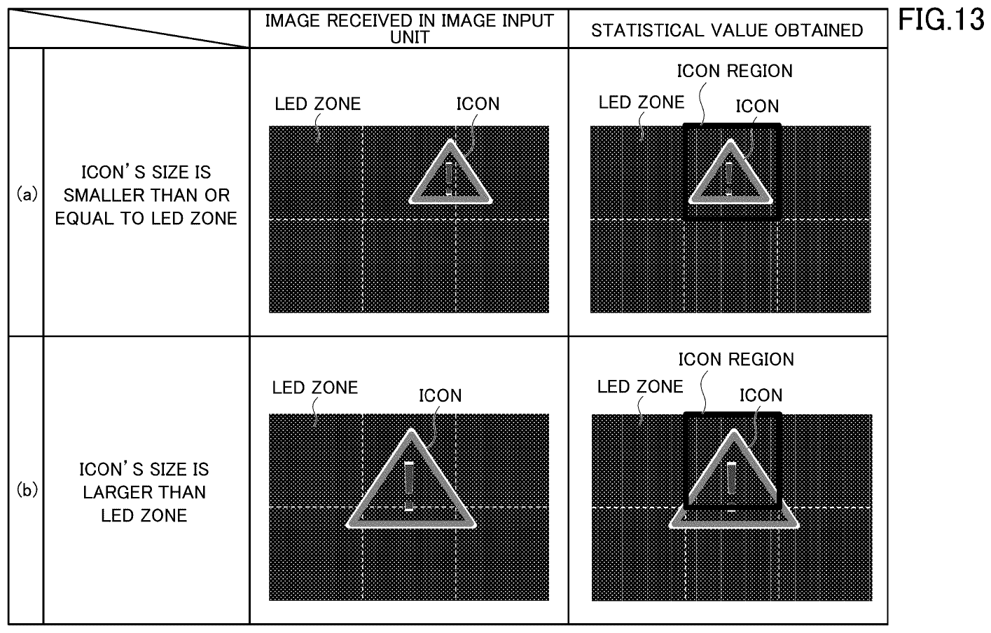

FIG. 13 is a diagram that illustrates example operations of the processor 400 mounted in the display controller 40, in an image display system according to a third embodiment. The image display system mounted in the display controller 40 including the processor 400 that operates as shown in FIG. 13 has the same structure and functions as those of the image display system 1 shown in FIG. 1. Elements that are the same or substantially the same as those described earlier with reference to FIG. 1 to FIG. 10 will be assigned the same reference codes, and their detailed description will be omitted.

The input statistics obtaining unit 240 and the output statistics obtaining unit 260 obtain the same statistical data as in FIG. 7. The method that the processor 400 uses to detect anomalies in the local dimming unit 250 is the same as that shown in FIG. 8. The process that is performed when an anomaly is detected in the local dimming unit 250 is the same as that shown in FIG. 10.

In this embodiment, the input statistics obtaining unit 240 and the output statistics obtaining unit 260 obtain statistical data based on the pixel values of the images of the LED zones where the icon region is placed. Furthermore, the processor 400 detects anomalies in the local dimming unit 250 per LED zone including the icon region.

FIG. 13 also shows, for ease of explanation, examples in which the backlight 60 has 6 LED light sources. (a) of FIG. 13 shows a case in which, in an image received by the image input unit 210, the size of the icon is smaller than or equal to the size of an LED zone. In this case, the processor 400 places the icon at a location where the icon border on multiple LED zones, and at the closest location to the original location of the icon. The processor 400 sets the LED zone including the icon as the icon region. Thus, the input statistics obtaining unit 240 and the output statistics obtaining unit 260 obtain statistical data based on the pixel values of the image of the LED zone where the icon is placed. In the processor 400, the functional unit that places the icon at a location where the icon border on multiple LED zones and sets the LED zone including the icon as the icon region, is an example of a superimposition region setting unit.

(b) of FIG. 13 shows a case in which, in an image received by the image input unit 210, the size of the icon is larger than the size of an LED zone. In this case, for example, the processor 400 sets the LED zone including a larger number of pixels of the icon than does any other LED zone, as the icon region. In the processor 400, the functional unit that sets the LED zone including a larger number of pixels of the icon than does any other LED zone as the icon part is an example of a superimposition setting unit.

When statistical data is obtained per LED zone to detect anomalies in the local dimming unit 250, the proportion of the icon in the icon region, which is an LED zone, decreases depending on where the icon is located. As a result of this, the statistical data becomes more susceptible to the influence of background images, and the accuracy of detection of anomalies in the local dimming unit 250 decreases. According to this embodiment, for example, the proportion of the icon in the icon region can be increased by moving the icon. Consequently, it is possible to make the statistical data less susceptible to the influence of background images, and prevent or substantially prevent the accuracy of detection of anomalies in the local dimming unit 250 from decreasing.

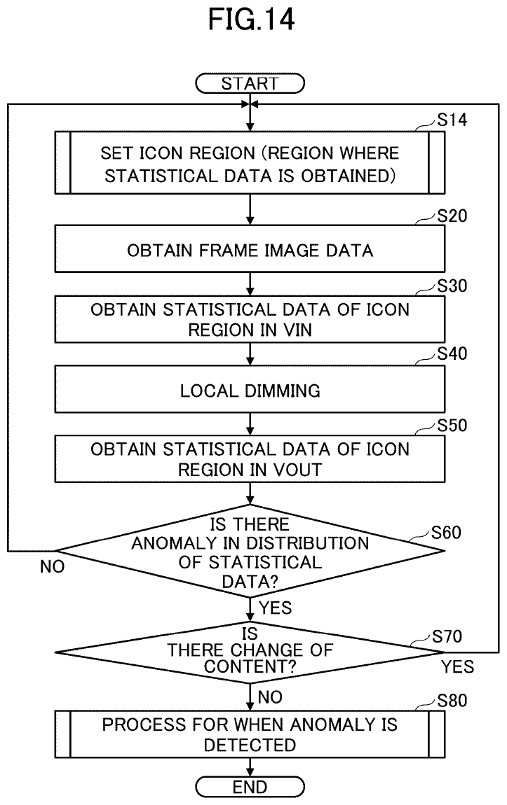

FIG. 14 is a flowchart that illustrates an example process in which the processor 400 that operates as shown in FIG. 13 detects anomalies in the local dimming unit 250. The structure and functions of the display controller 40 that performs the process of FIG. 14 are the same as those of the display controller 40 shown in FIG. 2 and FIG. 3, except that the processor 400 performs a different step.

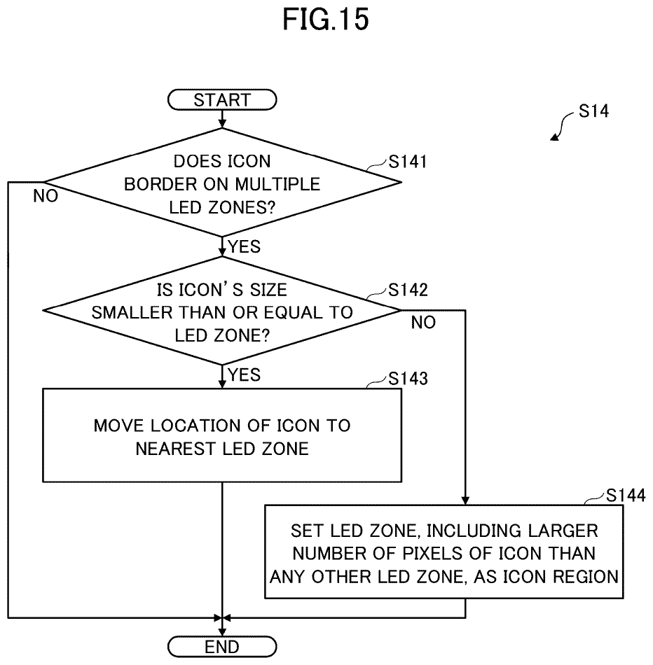

The processor 400 of this embodiment performs step S14 instead of step S10 in FIG. 9, during the step of detecting anomalies in the local dimming unit 250. As in FIG. 9, step S14 and step S20 to step S70 are performed per frame. Steps S20 to S80 are the same or substantially the same as those in FIG. 9. In step S14, the processor 400 sets the icon region for obtaining statistical data, and moves the process to step S20. An example of the process in step S14 is shown in FIG. 15.

Note that, when the content changes, the image display system 1 or the display controller 40 is activated, and so on, the processor 400 does not have to perform anomaly detection in step S60 for at least a period of 1 frame. In this case, the process returns to step S14 based on the assumption that the local dimming unit 250 is in normal condition.

FIG. 15 is a flowchart that illustrates an example of the process in step S14 of FIG. 14. First, in step S141, the processor 400 determines whether the icon is located to border on multiple LED zones. If the icon is located to border on multiple LED zones, the processor 400 shifts the process to step S142. If the icon is not located to border on multiple LED zones, that is, if the icon is included within a single LED zone, the processor 400 terminates the process of FIG. 15.

In step S142, the processor 400 determines whether the size of the icon is less than or equal to the size of an LED zone. If the size of the icon is less than or equal to the size of an LED zone, the processor 400 shifts the process to step S143. If the size of the icon is larger than the size of an LED zone, the processor 400 shifts the process to step S144.

In step S143, the processor 400 moves the icon to a location where the icon border on multiple LED zones and terminates the process of FIG. 15. For example, the processor 400 may move the icon to the LED zone including a larger number of pixels of the icon than does any other LED zone, or move the icon to the LED zone in which the center of the icon is located.

In step S144, the processor 400, for example, sets the LED zone including a larger number of pixels of the icon than does any other LED zone as the icon region where the icon is placed, and terminates the process of FIG. 15.

As described above, this embodiment can also bring about the same advantages as the above-described embodiments. For example, anomalies in the local dimming unit 250 can be detected based on the amount of difference between statistical data related to image data VIN and statistical data related to image data VOUT. When this is done, the content dependence of pixel values can be reduced by obtaining statistical data from the pixel values of a superimposition image such as an icon, so that appropriate standards can be set for anomaly detection. As a result of this, the accuracy of detection of anomalies in the local dimming unit 250 can be improved. Furthermore, when an anomaly is detected in the local dimming unit 250, it is still possible to prevent or substantially prevent an image with improper pixel values from being displayed on the display 50, and prevent or substantially prevent the LED light sources from being lit by the wrong backlight control signal BLCNT.

Furthermore, according to this embodiment, the proportion of the icon in the icon region is increased, so that it is possible to make the statistical data less susceptible to the influence of background images. As a result of this, it is possible to prevent or substantially prevent the accuracy of detection of anomalies in the local dimming unit 250 from decreasing.

### Fourth Embodiment

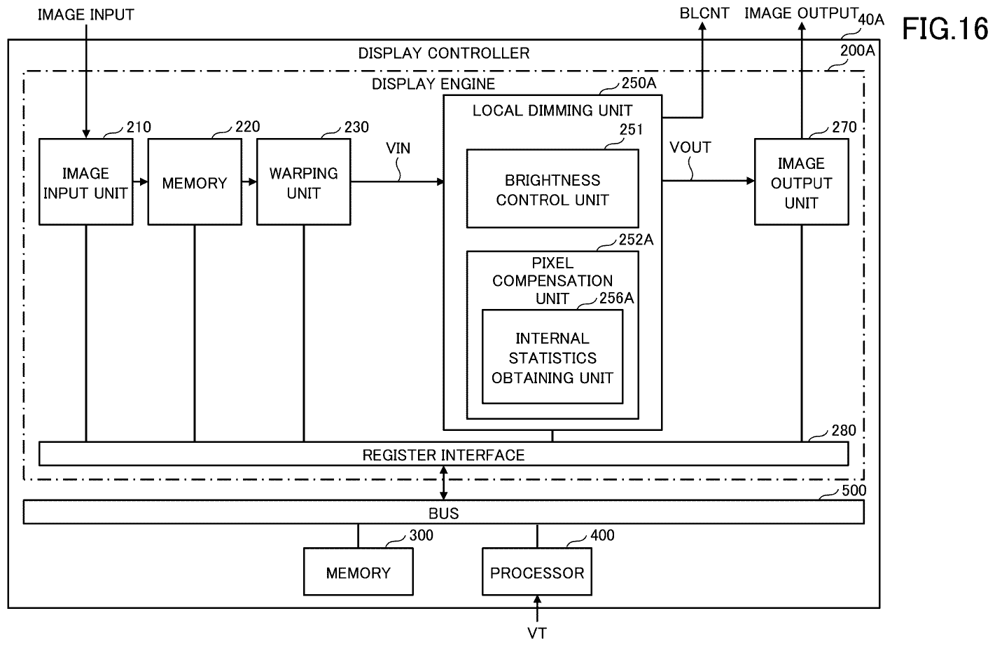

FIG. 16 is a block diagram that illustrates an example of a display controller 40A mounted in an image display system according to a fourth embodiment. The image display system equipped with the display controller 40A shown in FIG. 16 has the same structure and functions as those of the image display system 1 shown in FIG. 1. Elements that are the same or substantially the same as those described earlier with reference to FIG. 1 to FIG. 10 will be assigned the same reference codes, and their detailed description will be omitted. The process that is performed when an anomaly is detected in the local dimming unit 250 is the same as that in FIG. 10.

The display controller 40A shown in FIG. 16 has a display engine 200A instead of the display engine 200 shown in FIG. 2. In FIG. 16, the display engine 200A has a local dimming unit 250A instead of the local dimming unit 250 shown in FIG. 2.

The local dimming unit 250A has a pixel compensation unit 252A instead of the pixel compensation unit 252 shown in FIG. 2. The rest of the structures and functions of the display controller 40A and the display engine 200A are the same or substantially the same as those of the display controller 40 and the display engine 200 shown in FIG. 2. The pixel compensation unit 252A has the same structure and functions as the pixel compensation unit 252 shown in FIG. 3, except that an internal statistics obtaining unit 256A is added.

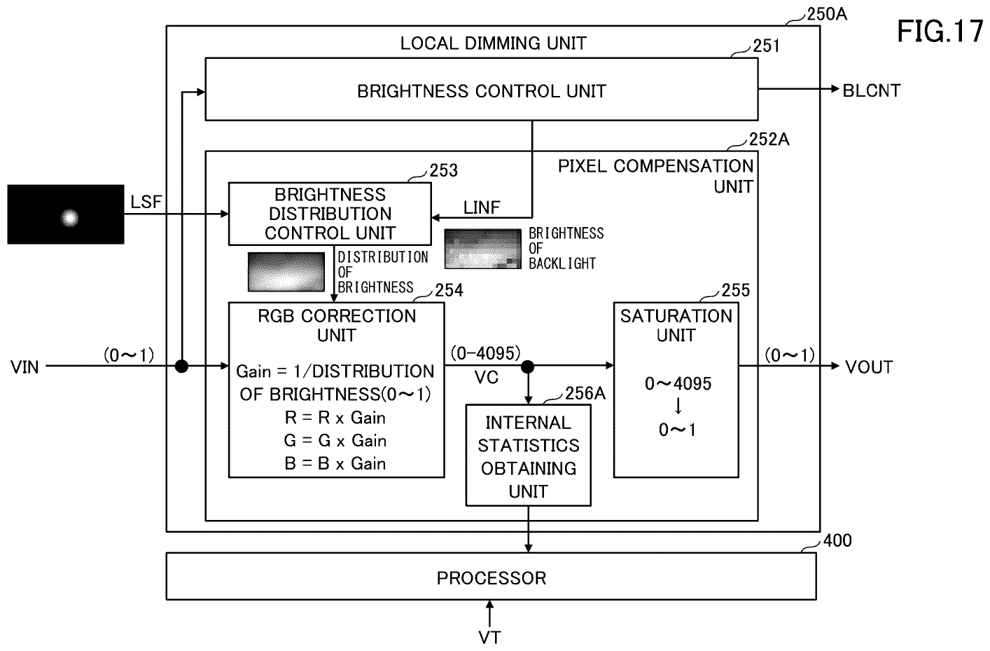

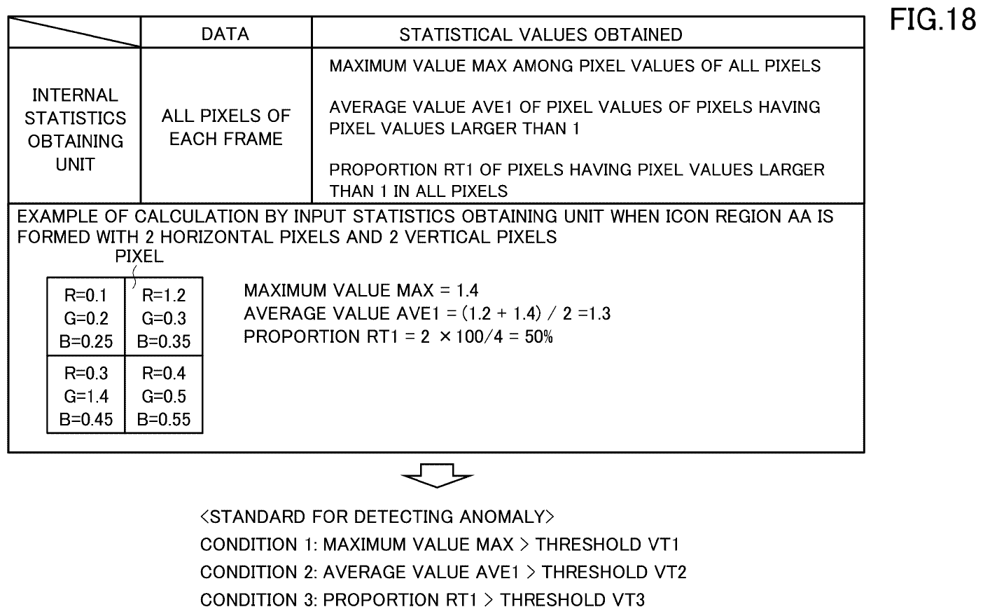

FIG. 17 is a block diagram that illustrates an example of the local dimming unit 250A of FIG. 16. Elements that are the same or substantially the same as those of the local dimming unit 250 of FIG. 3 will be assigned the same reference codes, and their detailed description will be omitted. In the pixel compensation unit 252A, the internal statistics obtaining unit 256A obtains statistical data based on the pixel values of all pixels in one frame included in image data VC output from the RGB correction unit 254. That is, the internal statistics obtaining unit 256 obtains statistical data based on pixel values included in image data VC, which the pixel compensation unit 252A generates during the process in which image data VOUT is generated from image data VIN. The statistical data that the internal statistics obtaining unit 256 obtains is an example of internal statistical data. The method that the internal statistics obtaining unit 256 uses to obtain the statistical data will be described with reference to FIG. 18.

FIG. 18 is a diagram that illustrates an example of statistical data obtained by the internal statistics obtaining unit 256A in FIG. 17. The internal statistics obtaining unit 256A obtains statistical data based on the pixel values of all pixels in each frame included in image data VC. For example, the internal statistics obtaining unit 256A determines the maximum value MAX among the pixel values of all pixels, the average value AVE1 of pixel values greater than 1 among all pixels, and the proportion RT1 of pixels having values greater than 1 in all pixels. As shown in FIG. 17, among the pixel values of the image data VC, the minimum value is 0 and the maximum value is 4095. The pixel value=1 of the image data VC is an example of a first pixel value.

In FIG. 17, as in FIG. 3, the pixel value of each color component of every pixel constituting the image data VIN and the image data VOUT is represented as a normalized value between 0 and 1, inclusive. Consequently, when the image input unit 210 of FIG. 16 receives, as an input, 8 bits (the first number of bits) of image data (0 to 255) per pixel, the maximum value 255 becomes 1 according to the representation of image data VIN in FIG. 17. When 8 bits (the first number of bits) of image data (0 to 255) are output per pixel, the maximum value 255 becomes 1 according to the representation of image data VOUT in FIG. 17.

FIG. 18 illustrates an example of calculation by the internal statistics obtaining unit 256A when the display 50 is formed with 2 horizontal pixels and 2 vertical pixels. In the example shown in FIG. 18, the internal statistics obtaining unit 256A obtains a maximum value MAX=1.4, an average value AVE1=1.3, and a proportion RT1=50%.

The processor 400 compares the maximum value MAX, the average value AVE1, and the proportion RT1 obtained by the internal statistics obtaining unit 256A against a first t threshold VT1, a second threshold VT2, and a third threshold VT3, respectively. Then, if a result that matches at least one of the following condition 1, condition 2, and condition 3 is yielded, the processor 400 detects an anomaly of the local dimming unit 250:
Condition 1: Maximum value MAX>First threshold VT1
Condition 2: Average value AVE1>Second threshold VT2
Condition 3: Proportion RT1>Third threshold VT3

The pixel values obtained from the gains calculated by the RGB correction unit 254 are usually greater than or equal to 0 and within a predetermined range, which is narrower than the range of 0 to 4095 in which image data VC can be represented. It then follows that, when the maximum value MAX is greater than the first threshold VT1, which is within the predetermined range, it is likely that there is some anomaly of the local dimming unit 250.

Similarly, the average of the pixel values of all pixels determined from the gains calculated by the RGB correction unit 254 is usually less than or equal to 1. It then follows that, when the average value AVE1 is greater than the second threshold VT2, it is likely that there is some anomaly of the local dimming unit 250. In addition, the proportion RT1 of pixels having pixel values greater than 1 in all pixels is usually smaller than or equal to the predetermined third threshold VT3. It then follows that, when the proportion RT1 is greater than the third threshold VT3, it is likely that there is some anomaly of the local dimming unit 250.

According to this embodiment, the processor 400 detects an anomaly of the local dimming unit 250 based on statistical data obtained from the pixel values of all pixels in image data VC. Therefore, the processor 400 can detect an anomaly of the local dimming unit 250 based not only on pixel values in the part where the icon is placed, but also on the pixel values of the region where the icon is not placed. For example, the processor 400 may detect an anomaly of the local dimming unit 250 per LED zone.

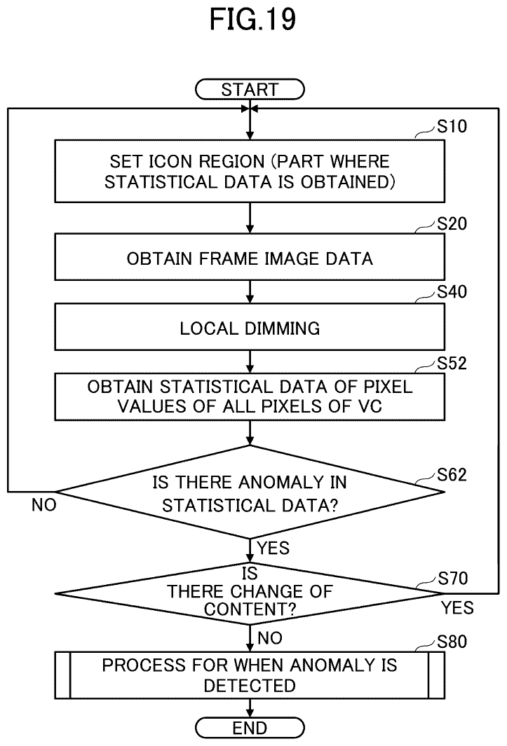

FIG. 19 is a flowchart that illustrates an example process in which the processor 400 of FIG. 17 detects anomalies in the local dimming unit 250A. That is, FIG. 19 illustrates an example of an image display control method that the processor 400 performs and an image display control program that the processor 400 executes. The flow shown in FIG. 19 is started upon activation of the image display system 1 or upon activation of the display controller 40.

As in FIG. 9, step S10 to step S70 are performed per frame. Steps S10, S20, S40, S70, and S80 are the same or substantially the same as steps S10, S20, S40, S70, and S80 of FIG. 9, respectively. The processor 400 performs step S40 after step S20. After step S40, the processor 400 performs step S52 instead of step S50 of FIG. 9.

In step S52, the internal statistics obtaining unit 256A obtains statistical data based on the pixel values of all pixels in one frame of image data VC. Next, in step S62, the processor 400 determines whether or not there is an anomalous value in the statistical data based on condition 1, condition 2, and condition 3 described above. If there is an anomalous value in the statistical data, the processor 400 shifts the process to step S70. If there is no anomalous value in the statistical data, the processor 400 returns the process back to step S10.

When the image display system 1 or the display controller 40 is activated, the processor 400 does not have to perform anomaly detection in step S62 for at least a period of 1 frame. In this case, the processor 400 returns the process back to step S10 based on the assumption that the local dimming unit 250 is in normal condition.

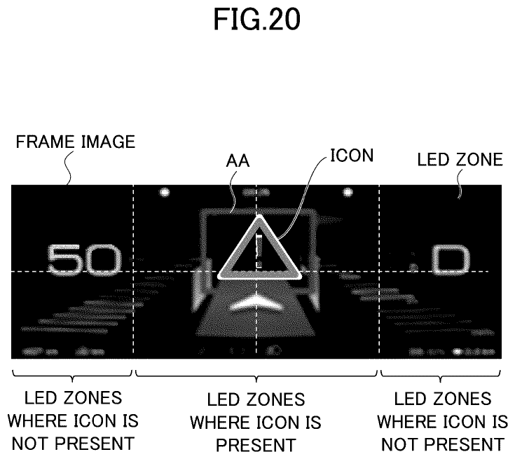

FIG. 20 is a diagram that illustrates an example of a frame image that is used to detect anomalies in the local dimming unit 250. As described above, the processor 400 detects anomalies in the local dimming unit 250 based on statistical data obtained from the pixel values of all pixels in image data VC. Therefore, the processor 400 can detect anomalies in the local dimming unit 250 not only in the LED zones where the icon is present but also in LED zones where the icon is not present.

As described above, this embodiment can bring about the same advantages as the above-described embodiments. Furthermore, according to this embodiment, anomalies in the local dimming unit 250 can be detected based on statistical data (an example of internal statistical data) obtained from the pixel values of image data VC generated in the pixel compensation unit 252A. When this is done, anomalies in the local dimming unit 250 can be detected based not only on pixel values in the region where the icon is present, but also on pixel values in regions where the icon is not present. As a result of this, anomalies in the local dimming unit 250 can be detected based on statistical data obtained from the pixel values of images in all LED zones.

The internal statistics obtaining unit 256A obtains a variety of statistical data such as the maximum value MAX among pixel values, the average value AVE1 of pixel values having values greater than 1, and the proportion RT1 of pixels having values greater than 1 in all pixels. The processor 400 compares the maximum value MAX, the average value AVE1, and the proportion RT1 against the first threshold VT1, the second threshold VT2, and the third threshold VT3, respectively. As a result of this, it is possible to apply more strict standards to the detection of anomalies in the local dimming unit 250, and improve the reliability of the display controller 40.

### Fifth Embodiment

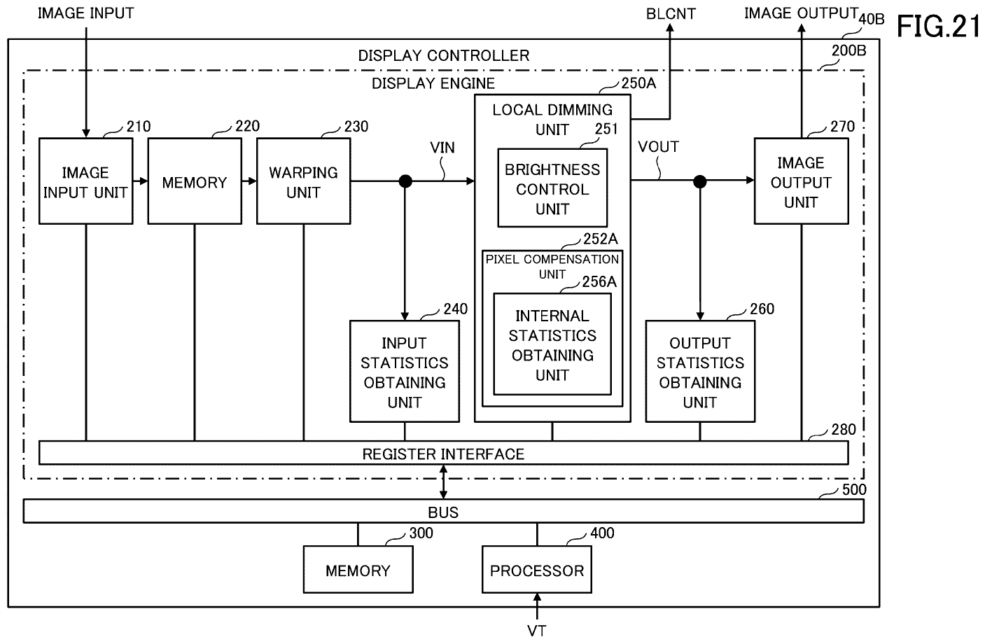

FIG. 21 is a block diagram that illustrates an example of a display controller 40B mounted in an image display system according to a fifth embodiment. The image display system equipped with the display controller 40B shown in FIG. 21 has the same structure and functions as those of the image display system 1 shown in FIG. 1. Elements that are the same or substantially the same as those described earlier with reference to FIG. 1 to FIG. 10 will be assigned the same reference codes, and their detailed description will be omitted. Elements that are the same or substantially the same as those of the display controller 40 in FIG. 2 will be assigned the same reference codes as in FIG. 2.

The display controller 40B shown in FIG. 21 includes a display engine 200B instead of the display engine 200 of FIG. 2. The display engine 200B includes a local dimming unit 250A of FIG. 17 instead of the local dimming unit 250 of FIG. 2. That is, an internal the display engine 200B includes statistics obtaining unit 256A in addition to the input statistics obtaining unit 240 and the output statistics obtaining unit 260 in FIG. 2. The rest of the structures and functions of the display controller 40A and the display engine 200A are the same as those of the display controller 40 and the display engine 200 of FIG. 2, respectively.

For example, the processor 400 detects anomalies in the local dimming unit 250A based on statistical data obtained by the input statistics obtaining unit 240, the output statistics obtaining unit 260, and the internal statistics obtaining unit 256A. Depending on the operation mode, the processor 400 may detect anomalies in the local dimming unit 250A based on either the statistical data obtained by the input statistics obtaining unit 240 and the output statistics obtaining unit 260 or the statistical data obtained by the internal statistics obtaining unit 256A.

When the statistical data deviates from any of the reference values (i.e. the range for detecting anomalies based on an upper-limit threshold and a lower-limit threshold, the first threshold VT1, the second threshold VT2, and the third threshold VT3, which have been described earlier), the processor 400 detects an anomaly of the local dimming unit 250. As a result of this, it is possible to apply even more strict standards to the detection of anomalies in the local dimming unit 250, and improve the reliability of the display controller 40 further.

As described above, this embodiment can also bring about the same advantages as the above-described embodiments. Furthermore, according to this embodiment, it is possible to apply more strict standards to the detection of anomalies in the local dimming unit 250, and improve the reliability of the display controller 40. By switching the mode of operation, an appropriate detection method can be selected from among multiple methods for anomaly detection.

Although the present invention has been described based on the above embodiments, the present invention is by no means limited to the specifics described in the above embodiments. A variety of changes can be applied to the present invention without departing from the scope of the present invention, and such changes can be designed as appropriate depending on the mode of implementation.

What is claimed is:

1. An image display control device with a local dimming function, the image display control device comprising:
a brightness control unit configured to control a brightness of each of a plurality of light sources based on first image information representing images to be displayed on a display unit, the plurality of light sources being included in a backlight;
a pixel compensation unit configured to generate second image information by correcting pixel values included in the first image information based on the brightness of each of the plurality of light sources;
a first statistics obtaining unit configured to obtain first statistical data with respect to the pixel values included in the first image information;
a second statistics obtaining unit configured to obtain second statistical data with respect to pixel values included in the second image information; and
an anomaly detection unit configured to detect an anomaly of the brightness control unit or the pixel compensation unit based on an amount of difference of the second statistical data from the first statistical data.

2. The image display control device according to claim 1,
wherein the images to be displayed on the display unit include an original image and a superimposition image to be superimposed on the original image,
wherein the first statistics obtaining unit is further configured to obtain the first statistical data with respect to a superimposition region in the first image information, the superimposition region including the superimposition image, and
wherein the second statistics obtaining unit is further configured to obtain the second statistical data with respect to the superimposition region in the second image information.

3. The image display control device according to claim 2, wherein the brightness control unit is further configured to make constant a brightness of a light source corresponding to the superimposition region among the plurality of light sources.

4. The image display control device according to claim 2, further comprising a superimposition region setting unit configured to, when the superimposition image is smaller than each of a plurality of light emitting zones that correspond to the plurality of light sources, place the superimposition image at a location where the superimposition image fits inside one light emitting zone and set the one light emitting zone, in which the superimposition image is placed, as the superimposition region.

5. The image display control device according to claim 2, further comprising a superimposition region setting unit configured to, when the superimposition image is larger than each of a plurality of light emitting zones that correspond to the plurality of light sources, set one light emitting zone that includes a larger number of pixels of the superimposition image than any other light emitting zone among the plurality of light emitting zones, as the superimposition region.

6. The image display control device according to claim 1,
wherein the first statistical data includes at least one of a maximum value, an average value, and a minimum value of the pixel values included in the first image information, and
wherein the second statistical data includes at least one of a maximum value, an average value, and a minimum value of pixel values included in the second image information, corresponding to the first statistical data.

7. The image display control device according to claim 1, wherein the anomaly detection unit is further configured to detect the anomaly of the brightness control unit or the pixel compensation unit when a proportion of change of the second statistical data relative to the first statistical data is beyond a predetermined range.

8. An image display control device with a local dimming function, the device comprising:
a brightness control unit configured to control a brightness of each of a plurality of light sources based on first image information representing images to be displayed on a display unit, the plurality of light sources being included in a backlight;
a pixel compensation unit configured to generate second image information by adjusting pixel values included in the first image information based on the brightness of each of the plurality of light sources;
an internal statistics obtaining unit configured to obtain internal statistical data of pixel values included in internal image information, the internal image information being generated during a process of generating the second image information from the first image information; and
an anomaly detection unit configured to detect an anomaly in local dimming based on the internal statistical data.

9. The image display control device according to claim 8,
wherein the pixel compensation unit is configured to generate the internal image information by correcting the pixel values included in the first image information based on the brightness of the plurality of light sources, the first image information being represented by a first number of bits and the internal image information being represented by a second number of bits that is an expansion of the first number of bits, and
wherein the internal statistical data includes at least one of:
a maximum value among pixel values included in the internal image information;
an average value of pixel values greater than a first pixel value among the pixel values included in the internal image information; or
a proportion of pixels having the pixel values greater than the first pixel value to all pixels.

10. The image display control device according to claim 9, wherein the anomaly detection unit is further configured to detect an anomaly of the brightness control unit or the pixel compensation unit when:
the maximum value is greater than a first threshold;
the average value is greater than a second threshold; or
the proportion is greater than a third threshold.

11. The image display control device according to claim 1, wherein the anomaly detection unit is further configured to prevent or substantially prevent an anomaly detection process from being executed for a period of at least one frame when content of the images displayed on the display unit changes or when the image display control device is started.

12. The image display control device according to claim 1, wherein the anomaly detection unit is further configured to, when the anomaly is detected, output the first image information as the second image information regardless of an operation of the pixel compensation unit, and light up the plurality of light sources regardless of an operation of the brightness control unit.

13. An image display control device comprising:
a display engine configured to perform a local dimming process; and
a processor configured to control an operation of the display engine,
wherein the display engine is configured to:
receive, as an input, first image information representing images to be displayed on a display unit;
hold the first image information;
control a brightness of each of a plurality of light sources based on the first image information, the plurality of light sources being included in a backlight;
generate second image information by correcting pixel values included in the first image information based on the brightness of the plurality of light sources;
obtain first statistical data with respect to the pixel values included in the first image information;
obtain second statistical data with respect to pixel values included in the second image information; and
output the second image information to the display unit, and
wherein the processor is configured to detect an anomaly of the local dimming process based on an amount of difference of the second statistical data from the first statistical data.

14. An image display control device comprising:
a display engine configured to perform a local dimming process; and
a processor configured to control an operation of the display engine,
wherein the display engine is configured to:
receive, as an input, first image information representing images to be displayed on a display unit;
hold the first image information;
control a brightness of a plurality of light sources based on the first image information, the plurality of light sources being included in a backlight;
generate second image information by correcting pixel values included in the first image information based on the brightness of the plurality of light sources;
obtain internal statistical data with respect to pixel values included in internal image information, the internal image information being generated during a process of generating the second image information from the first image information;
output the second image information to the display unit; and
detect an anomaly of the local dimming process based on the internal statistical data.

15. An image display system comprising:
the image display control device of claim 1;
the display unit;
the backlight, positioned facing the display unit;
a head unit configured to generate the images and output the first image information, representing the generated images, to the image display control device.

16. An image display system comprising:
the image display control device of claim 8;
the display unit;
the backlight, positioned facing the display unit; and
a head unit configured to generate the images and output the first image information, representing the generated images, to the image display control device.

17. An image display control method for use in an image display control device with a local dimming function, the image display control device including a brightness control unit, a pixel compensation unit, a first statistics obtaining unit, a second statistics obtaining unit and an anomaly detection unit, the image display control method comprising:
controlling, by the brightness control unit, a brightness of each of the plurality of light sources based on first image information representing images to be displayed on a display unit, the plurality of light sources being included in a backlight;
generating, by the pixel compensation unit, second image information by adjusting pixel values included in the first image information based on the brightness of each of the plurality of light sources;
obtaining, by the first statistics obtaining unit, first statistical data based on the pixel values included in the first image information;
obtaining, by the second statistics obtaining unit, second statistical data based on pixel values included in the second image information; and
detecting, by the anomaly detection unit, an anomaly in local dimming based on an amount of difference of the second statistical data from the first statistical data.

18. An image display control method for use in an image display control device with a local dimming function, the image display control device including a brightness control unit, a pixel compensation unit, an internal statistics obtaining unit, and an anomaly detection unit, the image display control method comprising:
controlling, by the brightness control unit, a brightness of each of the plurality of light sources based on first image information representing images to be displayed on a display unit, the plurality of light sources being included in a backlight;
generating, by the pixel compensation unit, second image information by adjusting pixel values included in the first image information based on the brightness of each of the plurality of light sources;
obtaining, by the internal statistics obtaining unit, internal statistical data of pixel values included in internal image information, the internal image information being generated during a process of generating the second image information from the first image information; and
detecting, by the anomaly detection unit, an anomaly in local dimming based on the internal statistical data.
